(19) United States
(12) Patent Application Publication
(10) Pub. No.: US 2023/0169558 A1
(43) Pub. Date: Jun. 1, 2023

(54) VENDOR SEARCH ASSISTANCE APPARATUS, VENDOR SEARCH ASSISTANCE SYSTEM, AND VENDOR SEARCH ASSISTANCE METHOD

(71) Applicant: CANON MEDICAL SYSTEMS CORPORATION, Tochigi (JP)

(72) Inventors: Yusuke TERAO, Nasushiobara (JP); Tatsuo OSAKA, Nasushiobara (JP)

(73) Assignee: CANON MEDICAL SYSTEMS CORPORATION, Tochigi (JP)

(21) Appl. No.: 18/058,802

(22) Filed: Nov. 25, 2022

(30) Foreign Application Priority Data
Nov. 26, 2021 (JP) 2021-192345

(51) Int. Cl. G06Q 30/06; G06Q 10/08

(52) U.S. Cl. CPC G06Q 30/0611; G06Q 30/0631; G06Q 10/08

(57) ABSTRACT

A vendor search assistance apparatus according to an embodiment includes: a memory that stores vendor information on each of plural vendors that have been registered; and processing circuitry configured to identify, on the basis of specification information of a proposition that has been advertised and the vendor information, recommended specification information that is recommended for the proposition, and notify a procurer that has advertised the proposition, of the recommended specification information.

### CROSS-REFERENCE TO RELATED APPLICATIONS

This application is based upon and claims the benefit of priority from Japanese Patent Application No. 2021-192345, filed on Nov. 26, 2021; the entire contents of which are incorporated herein by reference.

### FIELD

Embodiments described herein relate generally to a vendor search assistance apparatus, a vendor search assistance system, and a vendor search assistance method.

### BACKGROUND

Processes leading to manufacture of a product involve procurement of components used as parts of the product and procurement of substances used in the process of the manufacture. In such procurement, a procurer may make a search for vendors. Specifically, if the procurer wants to make deals at more favorable terms related to costs, quality, and delivery deadlines, the procurer advertises for a vendor for each proposition and selects the vendor from vendors that have applied to be the vendor.

### BRIEF DESCRIPTION OF THE DRAWINGS

FIG. 1 is a block diagram illustrating an example of a configuration of a vendor search assistance system according to a first embodiment;

FIG. 2 is a diagram illustrating a sequential flow of a vendor search according to the first embodiment;

FIG. 3 is a diagram illustrating a sequential flow of a vendor search according to the first embodiment;

FIG. 4 is a diagram illustrating a sequential flow of a vendor search according to the first embodiment;

FIG. 5 is a diagram illustrating a sequential flow of a vendor search according to the first embodiment; and

FIG. 6 is a diagram illustrating an example of a display screen according to the first embodiment.

### DETAILED DESCRIPTION

A vendor search assistance apparatus, a vendor search assistance system, and a vendor search assistance method will hereinafter be described in detail by reference to the appended drawings.

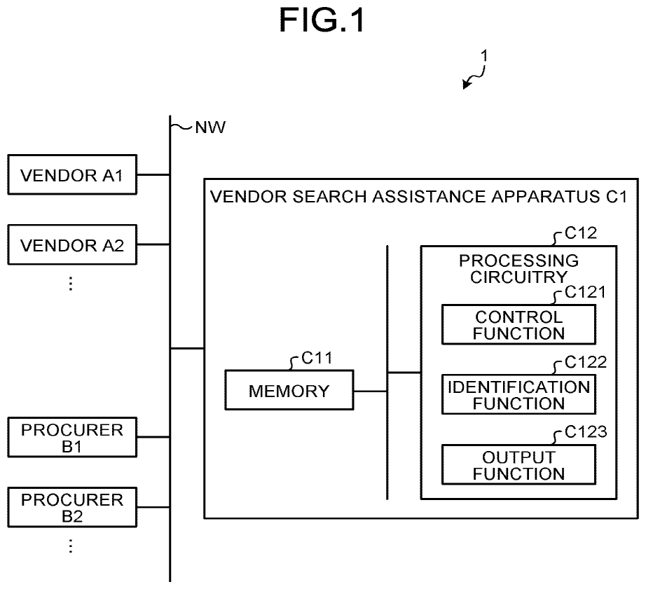

FIG. 1 illustrates an example of a configuration of a vendor search assistance system 1. The vendor search assistance system 1 includes a vendor search assistance apparatus C1, plural vendors (a vendor A1, a vendor A2, . . . ), and plural procurers (a procurer B1, a procurer B2, . . . ). The vendor search assistance apparatus C1 is configured to be capable of communicating with the plural vendors (the vendor A1, the vendor A2, . . . ) and the plural procurers (the procurer B1, the procurer B2, . . . ), via a network NW. The network NW is, for example, a network via the Internet.

As illustrated in FIG. 1, the vendor search assistance apparatus C1 includes a memory C11 and processing circuitry C12.

The memory C11 is implemented by, for example: a semiconductor memory element, such as a random access memory (RAM) or a flash memory; a hard disk; or an optical disk. For example, the memory C11 stores a program for the processing circuitry C12 to implement functions of the processing circuitry C12. The memory C11 also stores vendor information described later. The memory C11 may be implemented by a server group (cloud) connected to the vendor search assistance apparatus C1 via the network NW. The memory C11 is an example of a memory.

The processing circuitry C12 controls the overall operation of the vendor search assistance apparatus C1 by executing a control function C121, an identification function C122, and an output function C123. The identification function C122 is an example of an identification unit. The output function C123 is an example of an output unit.

For example, by reading a program corresponding to the control function C121 from the memory C11 and executing the program, the processing circuitry C12 controls various functions including the identification function C122 and the output function C123. Furthermore, on the basis of specification information of a proposition that has been advertised and the vendor information, the processing circuitry C12 identifies a recommended vendor from the plural vendors or identifies recommended specification information that is recommended for the proposition; by reading a program corresponding to the identification function C122 from the memory C11 and executing the program. Furthermore, by reading a program corresponding to the output function C123 from the memory C11 and executing the program, the processing circuitry C12 notifies the procurer that has advertised the proposition, of the recommended vendor or the recommended specification information, or notifies the recommended vendor of the specification information. Details of the functions of the processing circuitry C12 will be described later.

In the form of programs executable by a computer, the processing functions have been stored in the memory C11 of the vendor search assistance apparatus C1 illustrated in FIG. 1. The processing circuitry C12 is a processor that implements the functions corresponding to the programs by reading and executing the programs from the memory C11. In other words, the processing circuitry C12 that has read the programs has the functions corresponding to the read programs.

The control function C121, the identification function C122, and the output function C123 have been described to be implemented by the single piece of processing circuitry C12 in FIG. 1, but the processing circuitry C12 may include a combination of plural independent processors and these processors may implement the functions by executing the programs. Furthermore, any of the processing functions that the processing circuitry C12 has may be implemented by being distributed to plural pieces of processing circuitry or being integrated into a single piece of processing circuitry, as appropriate.

In addition, the processing circuitry C12 may implement a function by using a processor of an external device connected via the network NW. For example, the processing circuitry C12 may implement the functions illustrated in FIG. 1 by reading and executing the programs corresponding to the functions from the memory C11 and using a computational resource that is a server group (cloud) connected to the vendor search assistance apparatus C1 via the network NW.

The plural vendors (the vendor A1, the vendor A2, . . . ) illustrated in FIG. 1 include an information processing apparatus maintained by a company serving as one of the vendors. This information processing apparatus includes, for example, processing circuitry that controls input and output of information via the network NW and an input interface and a display for an employee of the company to operate the information processing apparatus. The plural procurers (the procurer B1, the procurer B2, . . . ) similarly include an information processing apparatus maintained by a company that performs procurement.

The example of the configuration of the vendor search assistance system 1 has been described hereinbefore. The vendor search assistance apparatus C1 in the vendor search assistance system 1 configured as described above provides assistance in searches for vendors appropriately.

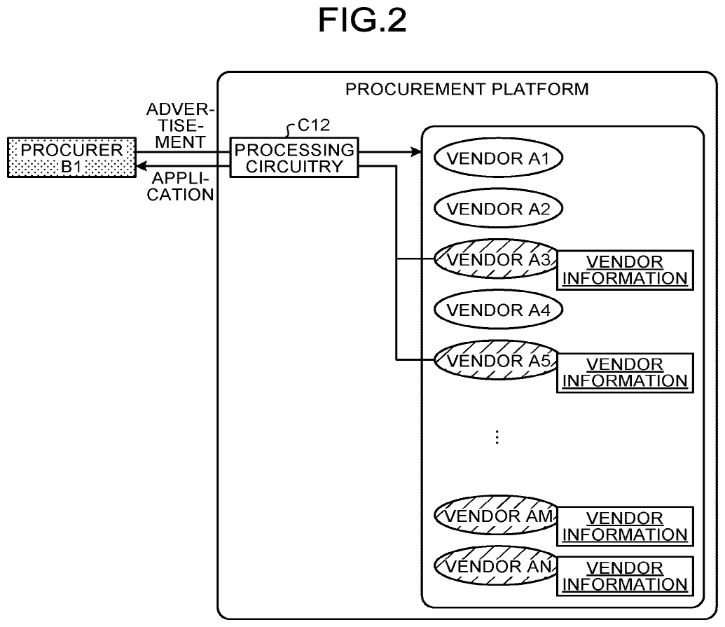

Firstly, an example of a search for a vendor will be described by use of FIG. 2. FIG. 2 illustrates a case where the procurer B1 that performs procurement makes the search for a vendor.

This procurer B1 may be a company that manufactures an end product, or may be a company that manufactures a part used in the manufacture of the end product. An apparatus for capturing medical images by use of X-rays (an X-ray diagnostic apparatus) will be described as an example. The X-ray diagnostic apparatus includes a device for generating X-rays (for example, an X-ray tube). Furthermore, the X-ray tube includes a part, such as a filament (a cathode). That is, the company that manufactures the filament (hereinafter, a company M1), the company that manufactures the X-ray tube (hereinafter, a company M2), and the company that manufactures the X-ray diagnostic apparatus (hereinafter, a company M3) are involved in a series of processes leading to manufacture of the X-ray diagnostic apparatus.

The company M2 may perform procurement of the filament to manufacture the X-ray tube. In this case, the company M2 serves as a procurer, and a filament manufacturing company, such as the company M1, serves as a vendor.

Furthermore, the company M3 may perform procurement of the X-ray tube to manufacture the X-ray diagnostic apparatus. In this case, the company M3 serves as a procurer and an X-ray tube manufacturing company, such as the company M2, serves as a vendor.

In procurement, the procurer B1 makes an advertisement, as illustrated in FIG. 2. Specifically, the procurer B1 sets specification information for each proposition and registers the specification information on a procurement platform. The specification information includes, for example, the lead time (LT), cost, dimensions, location of the procurer B1, and past records of deals.

More specifically, the memory C11 stores information (company names and IDs) on vendors registered on the procurement platform. Furthermore, the identification function C122 of the processing circuitry C12 receives specification information from the procurer B1 and registers the specification information on the procurement platform.

Any vendor registered on the procurement platform is able to refer to specification information of a proposition that has been advertised and apply to be a vendor, via the network NW, for example. FIG. 2 illustrates a case where the vendor A3 and the vendor A5 of plural registered vendors (the vendors A1 to A5, . . . , AM, and AN) have applied to be a vendor. In this case, the procurer B1 is able to select any one of the vendors A3 and A5 as a vendor.

In the case illustrated in FIG. 2, because some of the vendors, such as the vendor A1 and the vendor A2, have not applied to be a vendor, these vendors A1 and A2 will not be selected as a vendor. However, there is a possibility that such a vendor that has not applied to be a vendor is capable of offering conditions more favorable than those offered by the vendors that have applied to be a vendor. That is, there is potentially a vendor that is capable of offering conditions that are more favorable than those of the vendors that have applied to be a vendor, in terms of the cost, quality, and delivery deadline, for the proposition advertised by the procurer B1.

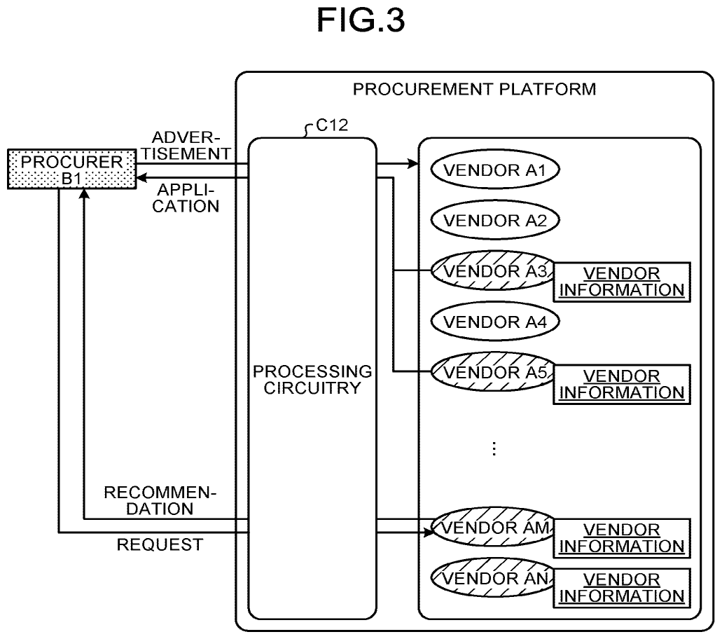

The vendor search assistance apparatus C1 thus provides assistance appropriately in a search for a vendor from vendors including any vendor that has not applied to be a vendor. This point will be described hereinafter by use of FIG. 3. FIG. 3 illustrates a case where the vendor A3 and the vendor A5 have applied to be a vendor for a proposition that has been advertised by the procurer B1, similarly to FIG. 2.

On the basis of specification information of the proposition advertised and the vendor information, the identification function C122 identifies a recommended vendor from the plural vendors that have been registered on the procurement platform. This vendor information is information associated with the vendors. The vendor information includes, for example, company information and performance information. The company information includes, for example, location information (region and country), production capacity, facilities owned, operational status of equipment, and received order situation. Furthermore, the performance information includes past records of deals, past records of received orders, and performance evaluation. The vendor information is stored in, for example, the memory C11.

The vendor information may be collected principally by the vendor search assistance apparatus C1 but may be registered principally by the vendors. For example, the vendor search assistance apparatus C1 may inquire of each vendor about company information and performance information and register vendor information on the basis of a reply to the inquiry. Furthermore, a vendor may access the vendor search assistance apparatus C1 via the network NW to update its own vendor information when the vendor has been registered on the procurement platform or when a change has been made in its company information and/or performance information. Registration of the vendor information by the vendor itself is going to be work done by the vendor but will also be a benefit to the vendor in that the vendor will expand opportunities to be selected for propositions.

The identification function C122 compares specification information of a proposition that has been advertised with the vendor information to identify a recommended vendor. For example, the identification function C122 identifies, as the recommended vendor, a vendor located near the procurer B1, a vendor high in production capacity and having extensive facilities, or a vendor that is not too busy in terms of operational status of equipment and received order situation, for example. Furthermore, for example, the identification function C122 identifies, as the recommended vendor, a vendor with many past records of deals and many past records of received orders or a vendor that has received high performance evaluations.

For example, the identification function C122 calculates a score for each of items, such as location information, production capacity, facilities owned, operational status of equipment, received order situation, past records of deals, past records of received orders, and performance evaluation, and identifies a recommended vendor on the basis of the total of these scores. Because vendor information that is updated more frequently is more reliable, the identification function C122 may raise the score of a vendor high in frequency of update of its vendor information. Furthermore, the identification function C122 may raise the score of a vendor who has applied to be a vendor for the relevant proposition.

The identification function C122 may identify recommended vendors respectively corresponding to plural evaluation criteria. For example, the identification function C122 may identify each of: a recommended vendor based on a geographical perspective; a recommended vendor based on a cost perspective; and a recommended vendor based on a qualitative perspective. Specifically, the identification function C122 may calculate a score for each of items, such as location information, production capacity, facilities owned, operational status of equipment, received order situation, past records of deals, past records of received orders, and performance evaluation, and identify a recommended vendor based on a geographical perspective by calculating the weighted average of the scores including the score that is based on the location information and that has been weighted largely. Furthermore, the identification function C122 may calculate a score for each of the items and identify a recommended vendor based on a cost perspective by calculating the weighted average of the scores including the score that is based on costs included in the past records of deals and that has been weighted largely. In addition, the identification function C122 may calculate a score for each of the items and identify a recommended vendor based on a qualitative perspective by calculating the weighted average of the scores including the score that is based on quality included in the performance evaluation and that has been weighted largely.

FIG. 3 illustrates a case where the vendor AM has been identified as a recommended vendor. In this case, the output function C123 notifies the procurer B1 of the vendor AM as the recommended vendor. That is, the output function C123 recommends the vendor AM to the procurer B1.

The identification function C122 may calculate a quotation supposed for a case where the vendor AM has received an order for a case advertised by the procurer B1, and the output function C123 may notify the procurer B1 of the vendor AM as a recommended vendor and may also notify the procurer B1 of the quotation. That is, in the case illustrated in FIG. 3, the vendor AM has not applied to be a vendor and thus does not generate a quotation. The vendor search assistance apparatus C1 may thus generate a prospective quotation and notify the procurer B1 of the prospective quotation. This prospective quotation may be generated on the basis of performance information on the vendor AM.

In a case where the procurer B1 selects the vendor AM, the output function C123 requests the vendor AM to apply to be a vendor for the advertisement by the procurer B1. The output function C123 may transmit specification information of the proposition advertised, to the vendor AM. In a case where the vendor AM applies to be a vendor, the procurer B1 and the vendor AM will start making a deal. The procurer B1 may make a request to the vendor AM directly without making the request via the vendor search assistance apparatus C1.

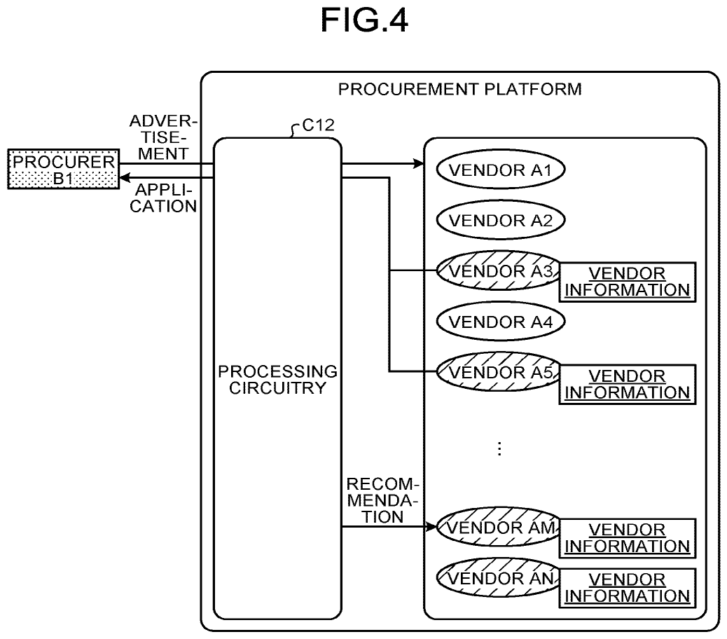

In the case of FIG. 3, the procurer B1 is notified after the vendor AM is identified as a recommended vendor, but the vendor search assistance apparatus C1 may notify the vendor AM first. This point will be described hereinafter by use of FIG. 4. FIG. 4 illustrates a case where the vendor A3 and the vendor A5 have applied to be a vendor for a proposition advertised by the procurer B1, similarly to FIG. 2 and FIG. 3. Similarly to FIG. 3, in the case illustrated in FIG. 4, the vendor AM is identified as a recommended vendor.

After the vendor AM is identified as a recommended vendor, the output function C123 notifies the vendor AM of specification information of the proposition advertised by the procurer B1. That is, the output function C123 recommends the proposition advertised by the procurer B1, to the vendor AM. If the vendor AM then just applies to be a vendor, the vendor AM is likely to reach a deal with the procurer B1. That is, the vendor search assistance apparatus C1 is able to provide an opportunity for a deal to the vendor AM.

The processing in FIG. 3 and the processing in FIG. 4 may be performed in combination with each other. That is, the output function C123 may notify the procurer B1 of a recommended vendor and notify the vendor AM of specification information of the proposition advertised by the procurer B1.

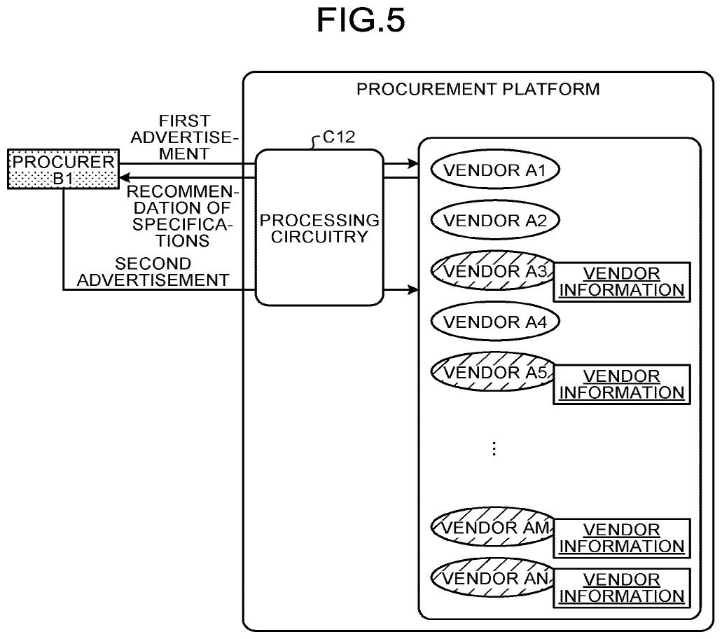

In the cases illustrated in FIG. 3 and FIG. 4, identification of a recommended vendor is performed. However, this embodiment is not limited to these cases. Specifically, instead of or in addition to identifying a recommended vendor, the identification function C122 may identify recommended specification information that is recommended for the proposition that has been advertised. This point will be described hereinafter by use of FIG. 5.

Firstly, the procurer B1 makes an advertisement (hereinafter, a first advertisement), similarly to the cases in FIG. 2 to FIG. 4. The identification function C122 identifies, on the basis of specification information in the first advertisement and the vendor information on the vendors, recommended specification information that is recommended.

For example, the identification function C122 extracts, from performance information on the vendors, information related to any proposition similar to the proposition advertised by the procurer B1. For example, the identification function C122 extracts performance information including information on a cost, a delivery deadline, and required quality, the information being similar to that of the proposition advertised by the procurer B1.

Subsequently, the identification function C122 compares the extracted performance information and the specification information in the first advertisement with each other and identifies recommended specification information. For example, in a case where the extracted performance information and the specification information in the first advertisement have about the same cost and delivery deadline but the required quality is too high, none of the vendors may apply to be a vendor. On the contrary, in a case where the extracted performance information and the specification information in the first advertisement have about the same cost and delivery deadline but the required quality is low, the cost may be reduced or the delivery deadline may be brought forward. As described above, the identification function C122 identifies recommended specification information by adjusting the balance between: the cost and delivery deadline; and the required quality.

Subsequently, the output function C123 notifies the procurer B1 of the recommended specification information. That is, the output function C123 makes a recommendation of specifications to the procurer B1. In a case where the procurer B1 determines that the recommended specification information is adequate enough, as illustrated in FIG. 5, a second advertisement is made on the basis of the recommended specification information. The advertisement is thereby made with conditions that will attract more applications and the efficiency of the process leading to determination of a vendor is able to be improved. Furthermore, advertisement with the minimum possible conditions that will attract applications enables the procurer B1 to gain benefits, such as improvement of quality and cost reduction.

The vendor information on the procurement platform is updated through inquiry from the vendor search assistance apparatus C1 to the vendors or voluntary access from the vendors, as described above. For example, the vendor information may be updated in real time through periodic inquiries from the vendor search assistance apparatus C1 to the vendors or an inquiry upon a large change in the international situation or occurrence of a disaster, for example. Furthermore, updating the vendor information is beneficial to the vendors themselves for more opportunities for the vendors to be selected for propositions and the vendor information is thus updated in real time by voluntary access from the vendors.

By updating the vendor information in real time, the vendor search assistance apparatus C1 is able to avoid supply chain disruptions or assist in restructuring supply chains. For example, in a case where a large-scale disaster occurs at the location of a vendor registered on the procurement platform, the identification function C122 identifies, as the recommended vendor described above, a vendor in a region not affected by the disaster. The procurer B1 then selects the recommended vendor and a supply chain disruption caused by the disaster is thereby avoided, or a supply chain is thereby restructured.

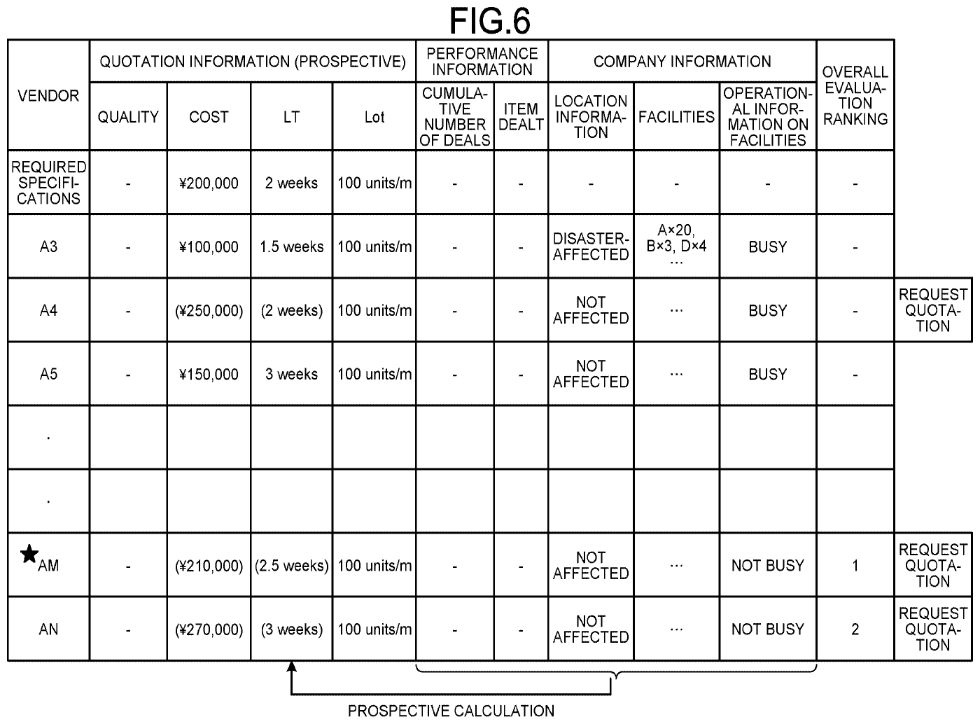

FIG. 6 illustrates an example of display of a notification by the vendor search assistance apparatus C1. FIG. 6 illustrates, as an example, a case where the procurer B1 is notified of a recommended vendor as illustrated in FIG. 3. A display screen in FIG. 6 corresponds to data generated by the output function C123 and transmitted to the procurer B1 via the network NW and is displayed on a display equipped in the procurer B1, for example.

FIG. 6 illustrates a case where the vendor AM has been identified as a recommended vendor, similarly to FIG. 3. In this case, the output function C123 highlights the vendor AM in the notification. For example, as illustrated in FIG. 6, the output function C123 generates a display screen having a cell for the vendor AM, the cell having been marked with a star, and transmits the display screen to the procurer B1.

Furthermore, the output function C123 may provide a column for overall evaluation rankings, as illustrated in FIG. 6. For example, the identification function C122 calculates a score for each of items including location information, production capacity, facilities owned, operational status of equipment, received order situation, past records of deals, past records of received orders, and performance evaluation, and identifies a recommended vendor on the basis of the total of these scores. In this case, the output function C123 may determine an overall evaluation ranking of each vendor, according to the total of these scores.

Similarly to FIG. 3, FIG. 6 illustrates a case where the vendor A3 and the vendor A5 have applied to be a vendor. The vendor A3 and the vendor A5 are able to obtain quotation information on the cost and LT, for example, when applying to be a vendor. On the contrary, the vendor A4, the vendor AM, and the vendor AN are unable to obtain the quotation information because they have not applied to be a vendor. As described above, the identification function C122 may calculate a prospective quotation. Furthermore, the prospective quotation may be displayed to be distinguishable from a quotation generated by a vendor. For example, as illustrated in FIG. 6, the cost and LT prospectively quoted for each of the vendor A4, vendor AM, and vendor AN may be parenthesized.

Furthermore, for a vendor, for which a prospective quotation has been calculated, an icon, “Request Estimation”, may be displayed. In a case where the procurer B1 has selected the icon, the output function C123 notifies the selected vendor of specification information of the proposition advertised by the procurer B1. The vendor that has received the notification may generate a quotation and apply to be a vendor for the proposition advertised by the procurer B1. Furthermore, as illustrated in FIG. 6, the state of disaster at the location of an affected vendor may be displayed in the column for location information.

The display screen in FIG. 6 is just an example, and various modifications are possible. For example, the text may be colored in different colors to increase legibility of comparison between required specifications (specification information) and quotation results. For example, in FIG. 6, while the cost in the required specifications is “¥200,000”, the quotation by the vendor A3 is “¥100,000” and the quotation by the vendor A5 is “¥150,000”. Furthermore, the quotation for the vendor A4 is “¥250,000”, the quotation for the vendor AM is “¥210,000”, and the quotation for the vendor AN is “¥270,000”, although these are prospective quotations. Therefore, for example, the quotations for the vendors A3 and A5 may be displayed in red text and the quotations for the vendor A4, the vendor AM, and the vendor AN may be displayed in blue text.

Furthermore, the output function C123 may make a notification enabling distinction between: vendors that have applied to be a vendor; and vendors that have not applied to be a vendor. For example, the output function C123 generates a display screen having a column indicating whether or not each vendor has applied to be a vendor, the column having been added to the example in FIG. 6, and transmits the display screen to the procurer B1. In FIG. 6, vendors that have applied to be a vendor and vendors that have not applied to be a vendor are still able to be distinguished from each other because the quotations for the vendors that have not applied to be a vendor are in parentheses.

As described above, according to this first embodiment, the memory C11 stores vendor information on each of plural vendors that have been registered. Furthermore, on the basis of specification information of a proposition that has been advertised and the vendor information, the identification function C122 identifies a recommended vendor from the plural vendors or identifies recommended specification information that is recommended for that proposition. Furthermore, the output function C123 notifies the procurer that has advertised the proposition, of the recommended vendor or the recommended specification information, or notifies the recommended vendor of the specification information. Therefore, the vendor search assistance apparatus C1 according to the first embodiment is capable of appropriately assisting a search for a vendor.

That is, the vendor search assistance apparatus C1 identifies a recommended vendor from plural vendors that have been registered on a procurement platform. Furthermore, the vendor search assistance apparatus C1 notifies the procurer B1 of a recommended vendor or notifies the recommended vendor of specification information of a proposition that has been advertised. The vendor search assistance apparatus C1 may also identify, as the recommended vendor, a vendor that has not applied to be a vendor for an advertisement by the procurer B1. Therefore, the vendor search assistance apparatus C1 is able to assist a search for a vendor without overlooking a potential vendor that is capable of offering favorable conditions. Furthermore, the vendor search assistance apparatus C1 may identify, as the recommended vendor, a vendor that has never made any deal with the procurer B1. Therefore, the vendor search assistance apparatus C1 is able to assist the procurer B1 in a search for a vendor and provide opportunities for vendors to be selected for propositions.

Furthermore, the vendor search assistance apparatus C1 identifies recommended specification information that is recommended for a proposition advertised by the procurer B1 and notifies the procurer B1 of the recommended specification information. Therefore, the vendor search assistance apparatus C1 enables advertisement under appropriate conditions and is able to support searches for vendors.

The term, “processor”, used in the above description means, for example: a CPU; a graphics processing unit (GPU); or a circuit, such as an application specific integrated circuit (ASIC) or a programmable logic device (for example, a simple programmable logic device (SPLD), a complex programmable logic device (CPLD), or a field programmable gate array (FPGA)). In a case where the processor is a CPU, for example, the processor implements the functions by reading and executing programs stored in a storage. In contrast, in a case where the processor is, for example, an ASIC, instead of the programs being stored in a storage, the functions are directly incorporated, as logic circuits, in the circuit of the processor. The processor according to the embodiment is not necessarily configured as a single circuit, and plural independent circuits may be combined together to be configured as a single processor to implement their functions. Furthermore, plural components in each drawing may be integrated into a single processor to implement their functions.

Furthermore, the programs corresponding to the processing functions of the processing circuitry C12 have been described above to be stored by the memory C11 alone. However, the embodiment is not limited to this example. For example, plural memories C11 may be arranged in a distributed manner and the processing circuitry C12 may be configured to read the corresponding programs from the individual memories C11. Furthermore, instead of being stored in the memory C11, the programs may be directly incorporated in the circuit of the processor. In this case, by reading and executing the programs incorporated in the circuit, the processor implements the functions.

The components of the apparatuses according to the embodiment described above have been functionally and conceptually illustrated in the drawings and are not necessarily configured physically as illustrated in the drawings. That is, specific forms of distribution and integration of the apparatuses are not limited to those illustrated in the drawings, and all or part of each apparatus may be configured to be distributed or integrated functionally or physically in any units, according to various loads and/or use situations, for example. Furthermore, all or any part of the processing functions executed in the apparatuses may be implemented by a CPU and a program or programs analyzed and executed by the CPU or implemented as hardware by wired logic.

Furthermore, the vendor search assistance method described above with respect to the embodiment may be implemented by a computer, such as a personal computer or a work station, executing a program that has been prepared beforehand. This program may be provided via a network, such as the Internet. Furthermore, this program may be recorded in a computer-readable non-transitory recording medium, such as a hard disk, a flexible disk (FD), a CD-ROM, an MO, or a DVD, and executed by being read by a computer from the recording medium.

At least one embodiment described above enables assistance to be provided appropriately in searches for vendors.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A vendor search assistance apparatus, comprising:
a memory that stores vendor information on each of plural vendors that have been registered; and
processing circuitry configured to identify, on the basis of specification information of a proposition that has been advertised and the vendor information, recommended specification information that is recommended for the proposition, and notify a procurer that has advertised the proposition of the recommended specification information.

2. The vendor search assistance apparatus according to claim 1, wherein the vendor information includes company information.

3. The vendor search assistance apparatus according to claim 1, wherein the vendor information is updated in real time.

4. A vendor search assistance system, comprising:
plural procurers; and
a vendor search assistance apparatus comprising:
a memory that stores vendor information on each of plural vendors that have been registered; and
processing circuitry configured to identify, on the basis of specification information of a proposition that has been advertised and the vendor information, recommended specification information that is recommended for the proposition, and notify one of the plural procurers, of the recommended specification information, the one being a procurer that has advertised the proposition.

5. The vendor search assistance system according to claim 4, wherein the vendor information includes company information.

6. The vendor search assistance system according to claim 4, wherein the vendor information is updated in real time.

7. A vendor search assistance method, including:
identifying, on the basis of vendor information on each of plural vendors that have been registered and specification information of a proposition that has been advertised, recommended specification information that is recommended for the proposition; and
notifying a procurer that has advertised the proposition, of the recommended specification information.

8. The vendor search assistance method according to claim 7, wherein the vendor information includes company information.

9. The vendor search assistance method according to claim 7, wherein the vendor information is updated in real time.
